(19) United States
(12) Patent Application Publication
(10) Pub. No.: US 2005/0193007 A1
(43) Pub. Date: Sep. 1, 2005

(54) "E-filing. IT" (electronic Filing. IT)

(76) Inventors: Hector Manuel Cruz Lopez, Hampton, VA (US); Mildred Alice Caribe, Hampton, VA (US)

Correspondence Address: Hector M. Cruz Lopez, 132 Brinkman Dr., Hampton, VA, 23666, US

(21) Appl. No.: 10/788,214

(22) Filed: Feb. 27, 2004

(51) Int. Cl. G06F 17/30

(52) U.S. Cl. 707/104.1

(57) ABSTRACT

I (We) believe this to be true that e-Filing IT methodology is a new art that combines the three major sources of information on one CD. By digitizing pictures, videos and documents on one CD they can be reproduced from any printing system. The main objective is to collect information that will provide people with evidence, proof and/or accountability of their assets. The CD containing the collected data (video, picture and documentation) is easily stored and can be carried anywhere. Today's world normally uses one or two of the three data collections systems mentioned above, no one combines all three sources of information like us. e-Filing IT methodology will prove to be a unique service system.

### CROSS-REFERENCE TO RELATED APPLICATIONS

“Not Applicable”

### STATEMENT REGARDING FEDERALLY SPONSORED RESEARCH AND DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

“E-Filing. IT” is a start-up business that delivers, organizes, and Filings your important documents, pictures, and videos onto a disk/harddrive/CD/or DVD.

Imagine being able to clear piles of documents out of bulky storage cabinets and fireproof safes. “E-Filing. IT” is a full-service, computerized records management business providing secure storage and indexing of paper documents, pictures, analog/digital media, and videotapes. Efficiency is one benefit to “e-Filing. IT”—efficiency and cost effectiveness comes from being able to instantly access this stored information from a disk/CD/DVD. Security is another benefit—with just a few disks, you can safely store your valuable documents. Accessibility is yet another benefit—from any PC, you can easily access these documents at any time.

“E-Filing. IT” offers a reliable way to protect documents, pictures, and video—a true alternative to bulky storage cabinets and safes—will electronically save important documents, from real estate mortgages, property insurance, tax papers, and video—securely onto optical or magnetic media—prevent future headaches by saving on needed space, time, and money. Directly supports back-up/restores.

We have come to realize that consumers and businesses generally do not keep information on CD and/or DVD. They rather continue to use paper-filing systems, which can be easily destroyed. Such events can lead to delays in receiving prompt service and an inability to produce proper evidence (documents, pictures, receipts, videos, etc.) required by Insurance Companies, Government Agencies, and any other official organization as to the value of their assets. On the “Today Show” (NBC) it was stated that everyone should “have a bag ready to go in an Emergency.” The contents of such bag should include all necessary documents. Documents such as marriage licenses, birth certificate, deed of trust, wills, and any another documents of personal/business value.

### BRIEF SUMMARY OF THE INVENTION

“E-Filing. IT” is a full-service records management and information/data storage business—providing computerized records management and secure storage, as well as the indexing of paper records, analog/digital media, and other business—critical information media. Imagine an end to clutter generated by bulky, necessary and valuable, documents all stored onto a disk/CD/DVD (or other media such as thumb drive, etc) for peace of mind and yet available for easy access, archiving, and updating. We develop, organize, and store your documents electronically—like that old Filing cabinet, or safe—we store documents such as licenses, real estate mortgages, medical records, and property insurance forms. In addition, video versions can also be upgraded from VHS and/or Beta tapes. And you can control just what is added or deleted from each.

We will give our customers the competitive edge through state-of-the-art technology, unprecedented security and confidentiality, as well as quick-response service. In today's business environment, quick and easy access to critical information gives our customers a competitive advantage—they can store their records in an organized environment and improve the speed and ease of access to those records.

We will service our customers by providing a safe and reliable process for retaining documents in a secure, easy to store disk. We will aide in data recovery in the event of natural or man-made disasters. Insurance companies will appreciate the efficient data storage article created; saving valuable time by providing faster financial returns from any claims.

### BRIEF DESCRIPTION OF THE SEVERAL VIEWS OF THE DRAWING

“Not Applicable”

### DETAILED DESCRIPTION OF THE INVENTION

“E-Filing. IT” (Electronic Filing. IT) process for scanning documents—I (We) utilize a unique scanning bed “border” sheet or bed markings that allows for efficient scanning and saving without the need for cropping (i.e., you do not have to have the additional processing steps to manually set the paper size and paper dimensions).
Make sure all documents are place in order before scanning
Turn on all your equipment; i.e., Computer, monitor, scanner, digital camera
Once turned on: find the scanner logo, name or symbol on your Desktop
Once found then click on the logo to open
If manually fed, place documents into scanner one at a time; if, auto feed load sheet feeder
Once document is scanned select: preview or scan image
If selecting preview adjusts documents to fit parameters desired. Re-scan for exact image
Once image is re-scanned; save document with the name you want. Click save and it will download to the program you selected in your hard drive. (JPEG, WORD, Etcetera.)
If you select Scan Image then you will by-pass preview. Click save and it will download to the program you selected in your hard drive. (JPEG, WORD, Etcetera.)
Optional: Scan photographs (follow instructions 7 and 8 above.)
(0002) Process for Digital Camera
Turn on Computer and Monitor
Select Logo or name from desktop for digital camera
Download digital camera
View Pictures and select desired one to be named and saved
Save to Selected program in Hard Drive

Video Taping: 1. Follow instructions from VHS/DVD Camcorder. If using VHS tapes, the information will be burned to a CD/DVD with all other data and pictures. Data and pictures are added to CD/DVD.
Select program from desktop or at my computer logo where CD and/or DVD is archived
Indexing (Put in Order) through the selected program
Select process for coping all indexing
Insert blank Compact Disk (CD) and/or DVD into selected drive
Select “Copy” to computer drive and make copy
Label each CD and/or DVD with its content

1. “I (We) claim as our invention to be a simple technological method of having data (documents, pictures, receipts, videos, etc.) copied into an electronic devices (e.g. Compact Disk, diskette, thumb drive, etc.) for information readily available to consumers or businesses”.
At “e-Filing. IT” (electronic Filing. IT), we copy all necessary data (documents, pictures, receipts, videos, etc.) to a CD and/or DVD. The CD and/or DVD will enable the consumer or business the ability to review all their information. The main problem we see today is the loss of information whether voluntary or not. The loss of information results in heartache for consumers and nightmares for businesses. An electronic Filing will provide a visual copy of documents, pictures, and video clips, for the consumer and/or business and make it readily available to be reproduced. CD's and/or DVD's can be protected and stored much quicker than a room full of cabinets or a desk drawer.
